(19) United States
(12) Patent Application Publication
(10) Pub. No.: US 2017/0233270 A1
(43) Pub. Date: Aug. 17, 2017

(54) METHOD FOR TREATING BALLAST WATER

(71) Applicant: KURITA WATER INDUSTRIES LTD., Tokyo (JP)

(72) Inventors: Tetsuro FUKASE, Tokyo (JP); Kazuki HAYASHI, Tokyo (JP); Tamotsu ISHIBASHI, Tokyo (JP)

(21) Appl. No.: 15/502,841

(22) PCT Filed: Aug. 12, 2014
(86) PCT No.: PCT/JP2014/071345

§ 371 Date: Feb. 9, 2017

(51) Int. Cl. C02F 1/76; C02F 1/50; B63J 4/00

(52) U.S. Cl. CPC C02F 1/76; B63J 4/002; C02F 1/50; C02F 2209/11; C02F 2103/008

(57) ABSTRACT

This method entails: collecting in advance untreated ballast water to which a chlorine-based active substance has not been added; measuring in advance the turbidity of the untreated ballast water; and adding a chlorine-based active substance with an adding amount determined on the basis of the turbidity. The amount of the chlorine-based active substance to be added is set according to the turbidity such that the concentration of total residual oxidants (TRO) is 0.5-3 mg/L (asCl₂) when the ballast water is discharged.

### TECHNICAL FIELD

The present invention relates to a treatment method for controlling ballast water by determining an optimal adding amount of a chlorine-based active substance for ballast water treatment.

### BACKGROUND ART

Ships, especially cargo ships, are generally designed considering including weight of loaded cargos, etc., so that a ship in a state of loaded with no or few cargos takes in seawater at a port before departure to keep balance of the ship for the necessity of securing the propeller immersion depth and navigational safety, etc. during no cargo. The water used as ballast is called ships' ballast water. The ships' ballast water is seawater, etc. loaded to a ballast tank at a port when departing the port with no cargo, while the ships' ballast water is discharged when loading cargos at a port.

When filling and discharging ships' ballast water to and from ships moving between loading ports and unloading ports of different environments, there is a concern of adversely affecting ecosystems of coasts by difference of microorganisms included in the ships' ballast water between the loading port and unloading port. Therefore, at the international convention for the management of ships' ballast water, the international treaty for the Control and Management of Ships' Ballast Water and Sediments was adopted in February, 2004 and a treatment of ships' ballast water became obliged.

The standards of ships' ballast water treatment established by the International Maritime Organization (IMO) are that the number of living organisms of 50 μm or greater (mainly zooplankton) included in ships' ballast water to be discharged from ships is less than 10 per 1 m³, the number of living organisms of 10 μm or greater but smaller than 50 μm (mainly phytoplankton) is less than 10 in 1 ml, the number of cholera is less than 1 cfu per 100 ml, the number of Escherichia coli is less than 250 cfu per 100 ml, and the number of Intestinal Enterococci is less than 100 cfu per 100 ml.

To satisfy the treatment standard of ballast water as above, a ships' ballast water treatment method of killing microorganisms, etc. by adding a bactericidal agent of a chlorine-based active substance, such as sodium hypochlorite and calcium hypochlorite, to ships' ballast water and securing retention time has been proposed. An adding amount of the chlorine-based active substance in the ballast water treatment is determined based on a maximum allowance dosage (MAD) set in IMO basic approval.

However when adding a chlorine-based active substance to ballast water, as chlorine is consumed over time, it is desirable to calculate a consumption rate of the chlorine-based active substance and adding an amount required until when the ballast water is discharged, that is, until the end of navigation. As a method of calculating a consumption rate of chlorine, the chlorine attenuation estimation method using the formula below described in the patent document 1 is well known.

C=z·C₀·e^{-kt}

(In the formula, ‘C₀’ is a chlorine concentration at an outlet of a chlorine feeding pipe, ‘C’ is a chlorine concentration at time (t), ‘k’ is a reaction constant, ‘t’ is elapsed time and ‘z’ is a chlorine residual coefficient after feeding chlorine.)

### PRIOR ART DOCUMENTS

### Patent Article

[Patent Article 1] Japanese Patent Publication (Kokai) No. H08-41670

### DISCLOSURE OF THE INVENTION

### Problems to be Solved by the Invention

In the chlorine attenuation estimation method described in the patent document 1, however, a chlorine-based active substance was added often at a high concentration to ballast water when estimating, but an initial attenuation rate of the chlorine-based active substance is high in such a case, so that correlation becomes poor between the initial chlorine consumption rate and that thereafter and it was difficult to estimate a chlorine concentration after days based on a chlorine consumption amount in a relatively short time after adding the active substance, for example, 120 minutes or shorter, which was a problem.

Furthermore, water quality of actual ballast water varies due to many factors, such as pollution situation of its collecting place, water depth of collecting, collecting time and a period of navigation. The variations of water quality depend not simply on SS but on kinds and quantities of DOC, POC, ammonium, nitrous acid, inorganic salts and organic matters. However, known methods had a problem that they cannot follow different consumption rates of a chlorine-based active substance depending on those water quality variations.

To tackle therewith, an excessive amount of chlorine-based active substance may be possibly added with an expectation of a sufficient residual chlorine concentration even after days but it cannot be added more than the maximum allowance dosage (MAD). Furthermore, when determining an adding amount of a chlorine-based active substance for clear water, disadvantages arise such that most of the active substance remains at the time of discharging resulting in an increase of toxicity of discharged water and an adding amount of a neutralizer for discomposing the residual active substance becomes enormous. As explained above, there has not been any ballast water controlling method capable of optimally determining a temperate adding amount of the chlorine-based active substance while maintaining a total residual oxidizing substance concentration (residual chlorine concentration) to keep the bactericidal property until when the ballast water is discharged.

The present invention has an object thereof to provide a method for treating ballast water, with which the disadvantages above can be solved and an optimal adding amount of a chlorine-based active substance for a ballast water treatment can be determined.

### Means to Solve the Problems

To attain the above objects, the present invention provides a method for treating ballast water by adding a chlorine-based active substance for a bactericidal treatment on aqueous microorganisms in the ballast water when supplying obtained ballast water to a ballast tank, wherein turbidity of untreated ballast water not added with any chlorine-based active substance is measured in advance, and a chlorine-based active substance with an adding amount determined based on the turbidity is added to neutralize the ballast water (Invention 1).

According to the invention (Invention 1), untreated ballast water before actually adding any chlorine-based active substance is obtained and turbidity of the untreated ballast water is measured in advance. Present inventors found that a value of the turbidity correlates with an amount of harmful planktons, etc. and that a concentration of a chlorine-based active substance can be determined so that a total residual oxidizing substance concentration at the time of discharging can be regulated to be within a predetermined range based on the turbidity. As a result of determining an adding amount of the chlorine-based active substance in accordance with the turbidity value as above, it becomes possible to add a chlorine-based active substance in accordance with an amount of harmful planktons, etc. and excess or shortage of the chlorine-based active substance to be added can be prevented accordingly. Other effects of lowering toxicity of discharged water and reducing an adding amount of a neutralizer can be also obtained.

In the invention above (Invention 1), a total residual oxidizing substance concentration (TRO) in the ballast water is preferably 0.5 to 3 mg/L (asCl₂) at the time of discharging (Invention 2).

According to the invention (Invention 2), if a total residual oxidizing substance concentration (TRO) after neutralizing ballast water is 0.5 mg/L or more, harmful planktons and bacteria, etc. can be reduced to a reference value or below, while if 3 mg/L or less, the environmental burden at the time of discharging can be reduced. Only by adding a chlorine-based active substance in proportion to turbidity, a total residual oxidizing substance concentration as above can be attained.

In the inventions above (Invention 1 or 2), it is preferable that the chlorine-based active substance is added to attain 2 to 14 mg/L (asCl₂) when a value of the turbidity is less than 10 NTU, the chlorine-based active substance is added to attain 2 to 30 mg/L (asCl₂) when 10 NTU or more but less than 50 NTU, and the chlorine-based active substance is added to attain 18 to 30 mg/L (asCl₂) when 50 NTU or more (Invention 3).

Particularly in the invention above (Invention 3), when the turbidity value is 10 NTU or more but less than 50 NTU, a concentration of a chlorine-based active substance to be added is determined so as to satisfy

C=0.4X+a (1)

(In the formula, ‘C’ is a concentration of chlorine-based active substance to be added, ‘X’ is turbidity and ‘a’ is 2 to 10.) (Invention 4).

According to the inventions above (Inventions 3 and 4), by setting an adding amount of a chlorine-based active substance in accordance with the turbidity value in terms of a total residual oxidizing substance concentration, harmful planktons and bacteria, etc., can be reduced to a reference value or lower and the environmental burden at the time of discharging can be also reduced.

In the inventions above (Inventions 1 to 4), the chlorine-based active substance is preferably one or more kinds selected from dichloroisocyanuric acid, trichloroisocyanuric acid and hypochlorite (Invention 5).

According to the invention (Invention 5), those chlorine-based active substances are excellent in a bactericidal property against microorganisms included in ships' ballast water and are preferable for determining an adding amount thereof because calculation in the logarithm equation using a total residual oxidizing substance concentration approximates to an actual measurement value to a certain degree.

### Effect of the Invention

According to the treatment method of ballast water of the present invention, untreated ballast water before actually adding any chlorine-based active substance is obtained, turbidity of the untreated ballast water is measured in advance and an adding amount of the chlorine-based active substance is determined in accordance with a value of the turbidity, so that excessive adding or adding shortage of the chlorine-based active substance can be prevented. Also, toxicity of discharged water can be lowered and an adding amount of a neutralizer can be reduced.

### BRIEF DESCRIPTION OF DRAWINGS

FIG. 1 A graph showing a relation between turbidity and an adding concentration of sodium hypochlorite (chlorine-based active substance) in the treatment method of ballast water according to an embodiment of the present invention.

### MODE FOR CARRYING OUT THE INVENTION

Below, the treatment method of ballast water of the present invention will be explained in detail based on an embodiment.

The treatment method of ballast water of the present embodiment is to determine an adding amount of a chlorine-based active substance for a bactericidal treatment on aqueous microorganisms in ballast water when supplying the ballast water taken from a water inlet, wherein untreated ballast water not added with any chlorine-based active substance is obtained in advance, turbidity of the unreacted ballast water is measured in advance, a chlorine-based active substance with an adding amount determined based on the turbidity is added to neutralize the ballast water at discharging. Here, as a chlorine-based active substance, one or more kinds selected from dichloroisocyanuric acid, trichloroisocyanuric acid and hypochlorites may be used and particularly hypochlorite, such as sodium hypochlorite, is preferable because bactericidal property thereof is excellent and calculation in a logarithm equation using a total residual oxidizing substance concentration, which will be explained later on, approximates to an actual measurement value to a certain degree.

Note that a total residual oxidizing substance concentration indicates TRO (Total Residual Oxidants) and includes other oxidizing components generated by an oxidizing chlorine concentration as a result of adding a chlorine-based active substance and a reaction with the oxidizing chlorine. The total residual oxidizing substance concentration can be measured at a normal temperature by using a market-available high-precision TRO meter using DPD absorptiometry.

An adding amount of the chlorine-based active substance is set in accordance with turbidity so that the total residual oxidizing substance concentration (TRO) after neutralizing the ballast water becomes 0.5 to 3 mg/L (asCl₂) at the time of discharging. When the total residual oxidizing substance concentration (TRO) is less than 0.5 mg/L, it is difficult to reduce harmful planktons and bacteria, etc. to a reference value or lower or it leads to repopulation of bacteria and hatch of plankton eggs. On the other hand, when exceeding 3 mg/L, no further bactericidal effect on harmful planktons and bacteria, etc. can be obtained and, moreover, a neutralizer amount necessary for neutralizing increases or environmental burden increases when discharging, which are not preferable.

Specifically, when the turbidity value is less than 10 NTU, a chlorine-based active substance is added so as to attain 2 to 14 mg/L (asCl₂), when 10 NTU or more but less than 50 NTU, the chlorine-based active substance is added so as to attain 2 to 30 mg/L (asCl₂), and when 50 NTU or more, the chlorine-based active substance is added so as to attain 18 to 30 mg/L (asCl₂), consequently, the total residual oxidizing substance concentration (TRO) at the time of discharging can be 0.5 to 3 mg/L (asCl₂). Note that control based on turbidity as explained above may be done by using a turbidity meter.

Particularly when the turbidity value is 10 NTU or more but less than 50 NTU, by determining the concentration of the chlorine-based active substance to be added to be in a range of 2 to 30 mg/L (asCl₂), which satisfies the formula (1) below

C=0.4X+a (1)

(In the formula, ‘C’ is a concentration of added chlorine-based active substance, ‘X’ is turbidity and ‘a’ is 2 to 10.), the total residual oxidizing substance concentration (TRO) at discharging of 0.5 to 3 mg/L (asCl₂) can be obtained.

Also, when the turbidity value is less than 10 NTU, by applying the maximum value of ‘a’ in the formula (1) above and determining the concentration of the adding chlorine-based active substance to be in a range of 2 to 14 mg/L (asCl₂), which satisfies the formula (2) below

C₂=0.4X+10 (2)

(In the formula, ‘C₂’ is a concentration of a chlorine-based active substance to be added and ‘X’ is turbidity.), the total residual oxidizing substance concentration (TRO) at discharging of 0.5 to 3 mg/L (asCl₂) can be obtained.

When discharging ballast water, a reductant is supplied to the ballast water to be discharged so as to reduce residual chlorine, and the residual chlorine concentration is reduced to a targeted residual chlorine concentration before discharging to the external environment. As the reductant to be supplied from a reductant supply mechanism, sodium sulfite, sodium bisulfite (sodium hydrogensulfite) and sodium thiosulfate, etc. may be used.

The present invention was explained above based on one embodiment, however, the present invention is not limited to the embodiment and includes a variety of modified embodiments. For example, the total residual oxidizing substance concentration is not limited to measurement by a TRO meter using the DPD absorptiometry and a variety of measurement means may be used as long as corresponding measurement values can be obtained.

### EXAMPLES

The present invention will be explained furthermore in detail with specific examples below.

### Examples 1-11 and Comparative Examples 1-4

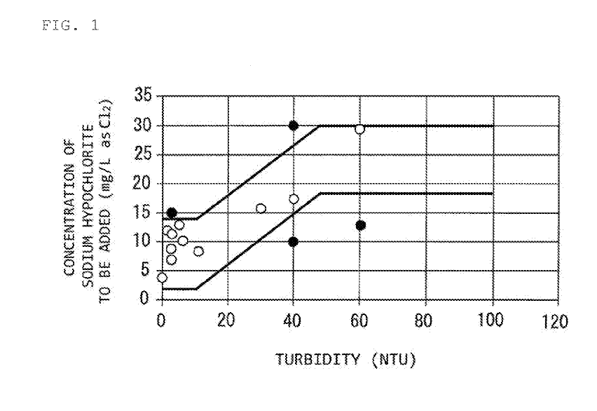

Seawater at ports of 10 places (seawater 1 to 10) were sampled and turbidity in each seawater was measured. To the respective seawater, sodium hypochlorite was added to attain the concentrations (in terms of chlorine) shown in Table 1. Then, each seawater was sealed and left still for 2 hours at 25° C. in a dark room before measuring its total residual oxidizing substance concentration by using the DPD method and the results are shown in Table 1. Note that those with the total residual oxidizing substance concentration (TRO) within a range of 0.5 to 3 mg/L (asCl₂) in Table 1 were considered as examples and others as comparative examples. In FIG. 1, those are indicated as being within the range of the thick solid lines (◯) and outside the range (). Also, a relation between turbidity and a concentration of sodium hypochlorite to be added (in terms of chlorine) in each of those examples 1 to 11 and comparative examples 1 to 4 is shown in FIG. 1, where those within the range of the thick solid lines are indicated as examples (◯) and those outside the range as comparative examples (), respectively.

TABLE 1

| | | | Concentration | |
|---|---|---|---|---|
| | Seawater | Turbidity | of Adding | TRO |
| Example No. | No. | (NTU) | (mg/L) | (mg/L) |
| Example 1 | Seawater 1 | 0 | 4.0 | 1.2 |
| Example 2 | Seawater 2 | 1.5 | 12.2 | 2.2 |
| Example 3 | Seawater 3 | 2.7 | 9.0 | 1.8 |
| Example 4 | Seawater 4 | 3 | 7.0 | 1.8 |
| Example 5 | Seawater 4 | 3 | 11.5 | 1.5 |
| Example 6 | Seawater 5 | 4.9 | 12.9 | 2.5 |
| Example 7 | Seawater 6 | 6.2 | 10.3 | 2.7 |
| Example 8 | Seawater 7 | 11 | 8.5 | 2.5 |
| Example 9 | Seawater 8 | 30 | 15.9 | 1.0 |
| Example 10 | Seawater 9 | 40 | 17.6 | 0.6 |
| Example 11 | Seawater | 60 | 29.9 | 0.9 |
| | 10 | | | |
| Comparative | Seawater 4 | 3 | 15.0 | 5.0 |
| Example 1 | | | | |
| Comparative | Seawater 9 | 40 | 10.0 | 0.2 |
| Example 2 | | | | |
| Comparative | Seawater 9 | 40 | 30.0 | 4.5 |
| Example 3 | | | | |
| Comparative | Seawater | 60 | 12.8 | 0.2 |
| Example 4 | 10 | | | |

As is clear from Table 1 and FIG. 1, in the examples 1 to 7, wherein the turbidity value was less than 10 NTU and the concentration of sodium hypochlorite to be added was in a range of 2 to 14 mg/L (asCl₂), the total residual oxidizing substance concentration after being left still for 2 hours was in a range of 0.5 to 3 mg/L (asCl₂), while in the comparative example 1, wherein the concentration of sodium hypochlorite to be added was 3 mg/L (asCl₂), the total residual oxidizing substance concentration after being left still for 2 hours was high as 5 mg/L (asCl₂), which was a level of requiring a large amount of neutralizer.

In the examples 8 to 10, wherein the turbidity value was 10 NTU or more and less than 50 NTU and the concentration of sodium hypochlorite to be added satisfies the formula (1) above, the total residual oxidizing substance concentration after being left still for 2 hours was in the range of 0.5 to 3 mg/L (asCl₂), while in the comparative example 2 with the concentration of sodium chlorite to be added being 10 mg/L (asCl₂) not satisfying the formula (1), the total residual oxidizing substance concentration after being left still for 2 hours was low as 0.2 mg/L (asCl₂), which was a level of being difficult to reduce harmful planktons and bacteria, etc. to the reference value or lower. On the other hand, in the comparative example 3 with the concentration of sodium hypochlorite to be added being 30 mg/L (asCl₂) not satisfying the formula (1), the total residual oxidizing substance concentration after being left still for 2 hours was high as 4.5 mg/L (asCl₂), which was a level of requiring a large amount of neutralizer.

Furthermore, in the example 11, wherein the turbidity value was 50 NTU or more (60 NTU) and the concentration of sodium hypochlorite to be added was in a range of 18 to 30 mg/L (asCl₂), the total residual oxidizing substance concentration after being left still for 2 hours was 0.9 mg/L (asCl₂), while in the comparative example 1 with the concentration of sodium hypochlorite to be added being 12.8 mg/L (asCl₂), the total residual oxidizing substance concentration after being left still for 2 hours was low as 0.2 mg/L (asCl₂), which was a level hard to reduce harmful planktons and bacteria, etc. to the reference value or lower.

It was learnt from the results above that, by setting the concentration of sodium hypochlorite to be added to be within the range of the thick solid lines in FIG. 1, particularly setting the concentration of a chlorine-based active substance to be added to be 2 to 14 mg/L (asCl₂) when the turbidity value is less than 10 NTU, setting the concentration of a chlorine-based active substance to be added to be in the range satisfying C=0.4X+a when the turbidity value was 10 NTU or more but less than 50 NTU and, furthermore, setting the concentration of chlorine-based active substance to be added to be in the range of 18 to 30 mg/L (asCl₂) when the turbidity value is 50 TNU or more, an adding amount of the chlorine-based active substance in the ballast water treatment can be set properly without any excess or shortage.

### INDUSTRIAL APPLICABILITY

According to the ballast water treatment method of the present invention, untreated ballast water before actually adding any chlorine-based active substance is obtained, turbidity of the untreated ballast water not added with any chlorine-based active substance is measured in advance and an adding amount of the chlorine-based active substance is determined in accordance with a value of the turbidity, consequently, an optimal adding amount of the chlorine-based active substance can be determined. Therefore, it is possible to optimize a loading amount of chemicals, space and facility on a ship, and a cost-competitive treatment apparatus can be provided eventually.

1. A method for treating ballast water by adding a chlorine-based active substance for a bactericidal treatment on aqueous microorganisms in the ballast water when supplying obtained ballast water to a ballast tank, wherein
turbidity of untreated ballast water not added with any chlorine-based active substance is measured in advance, and a chlorine-based active substance with an adding amount determined based on the turbidity is added to neutralize the ballast water.

2. The method for treating ballast water according to claim 1, wherein a total residual oxidizing substance concentration (TRO) in the ballast water is 0.5 to 3 mg/L (asCl₂) at the time of discharging.

3. The method for treating ballast water according to claim 1, wherein the chlorine-based active substance is added to attain 2 to 14 mg/L (asCl₂) when a value of the turbidity is less than 10 NTU, the chlorine-based active substance is added to attain 2 to 30 mg/L (asCl₂) when 10 NTU or more but less than 50 NTU, and the chlorine-based active substance is added to attain 18 to 30 mg/L (asCl₂) when 50 NTU or more.

4. The method for treating ballast water according to claim 3, wherein when a value of the turbidity is 10 NTU or more but less than 50 NTU, a concentration of a chlorine-based active substance to be added is determined so as to satisfy
C=0.4X+a (1)
(In the formula, ‘C’ is a concentration of chlorine-based active substance to be added, ‘X’ is turbidity and ‘a’ is 2 to 10).

5. The method for treating ballast water according to claim 1, wherein the chlorine-based active substance is one or more kinds selected from dichloroisocyanuric acid, trichloroisocyanuric acid and hypochlorite.
